(19) United States
(12) Patent Application Publication
(10) Pub. No.: US 2008/0223520 A1
(43) Pub. Date: Sep. 18, 2008

(54) SEPARATING APPARATUS, SEPARATING/TAKING-OUT APPARATUS, PROCESSING APPARATUS, SEPARATING METHOD, AND SEPARATING/TAKING-OUT METHOD FOR SHEET MATERIALS

(75) Inventors: Kiminori Toya, Kawasaki-shi (JP); Shunsuke Hattori, Kawasaki-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: KABUSHIKI KAISHA TOSHIBA

(21) Appl. No.: 12/045,193

(22) Filed: Mar. 10, 2008

(30) Foreign Application Priority Data
Mar. 12, 2007 (JP) 2007-062359

(51) Int. Cl. B32B 38/10; B29C 63/00

(52) U.S. Cl. 156/344; 156/584

(57) ABSTRACT

A sheet material separating apparatus includes a sheet material separating unit. This unit includes a low frictional guide sheet making a surface contact with an upper surface of an uppermost one in stacked sheet materials, and a vibrator contacting a surface of the guide sheet opposite to another surface of the guide sheet contacting the upper surface of the uppermost sheet material. A length from a part of the surface of the guide sheet on which the vibrator contacts to any position on a peripheral edge of the surface is longer than one wavelength of an excited sound wave.

### CROSS-REFERENCE TO RELATED APPLICATIONS

This application is based upon and claims the benefit of priority from prior Japanese Patent Application No. 2007-062359, filed Mar. 12, 2007, the entire contents of which are incorporated herein by reference.

### BACKGROUND OF THE INVENTION

1. Field of the Invention

The present invention relates to a separating apparatus, a separating/taking-out apparatus, a processing apparatus, a separating method, and a separating/taking-out method for sheet materials.

2. Description of the Related Art

A sheet material separating/taking-out apparatus including a sheet material separating apparatus is used in a sheet material processing apparatus, for example, a printer, a copier, an automatic teller machine (ATM), and a processing machine for processing securities including bank notes, and a processing apparatus for mail including postcards and letters.

A sheet material separating apparatus is strongly demanded to securely separate stacked sheet materials one by one at all times. A sheet material separating/taking-out apparatus is strongly demanded to securely separate and take out stacked sheet materials one by one at all times.

However, in a case that a sheet material is made of fibers, one group of two or three sheet materials in which the two or three sheet materials are closely in contact with each other may be taken out at a time. It is considered that this phenomenon is caused by entanglement of fibers rising from each sheet material surface or an increased frictional resistance between the closely contacted sheet materials due to the surface roughness of each sheet material.

Also, in a case that the surface of a sheet material is very smooth, one group of two or three sheet materials in which the two or three sheet materials are closely in contact with each other may be taken out at a time. And in this case, the neighbor sheet materials are closely in contact with each other because air is ejected from a clearance between the neighbor sheet materials while the sheet materials are stacked for a long time, or the neighbor sheet materials may be closely in contact with each other due to static electricity.

There are various prior arts to prevent a taking out of one group of two or three or more sheet materials at one time. One prior art is called as a frictional separating system. In this system, a pair of conveying roller and separating roller is provided to face to each other with a clearance therebetween, and the clearance is set slightly larger than the thickness of one sheet material. Further, the conveying roller and the separating roller are rotated in different directions. One sheet material group separated and taken out from the large number of stacked sheet materials is introduced into the clearance between the conveying roller and the separating roller. Where the sheet material group includes only one sheet material, the only one sheet material of the sheet material group can pass through the clearance. Where the sheet material group includes two or three or more sheet materials and the sheet material group is introduced into the clearance between the conveying roller and the separating roller, one sheet material or two or more sheet materials overlapped on only one sheet material located near to the conveying roller comes or come into contact with the separating roller and is or are separated from the only one sheet material, so that the only one sheet material can pass through the clearance.

Another prior art to prevent a taking out of one group of two or three or more sheet materials at one time is called as a vacuum suction separating system. In this system, only an uppermost sheet material of stacked sheet materials is separated from the other stacked sheet materials by using a vacuum suction apparatus.

JP-A 2004-2044 (KOKAI) discloses still another prior art called as a vibrating/separating system. In this system, a slender high-frequency vibrator is in contact with an uppermost one of stacked sheet materials at each of two positions separated from each other in a sheet material taking-out direction on the upper surface of the uppermost sheet material. And, the slender high-frequency vibrator extends all over the upper surface of the uppermost sheet material in its width direction.

While the two slender high-frequency vibrators are vibrated at a high frequency, a feed roller contacts the uppermost sheet material of the stacked sheet materials, and the uppermost sheet material is separated from the other stacked sheet materials and taken out by the feed roller.

In the above-mentioned conventional frictional separating system, if two or three or more sheet materials included in one sheet material group are relatively closely in contact with each other, the closely contacting sheet materials may not be separated from each other by the pair of conveying roller and the separating roller. As a result, the clearance between the conveying roller and the separating roller may be clogged with the two or three or more sheet materials included in the one sheet material group.

Even in the vacuum suction separating system, one or two or more sheet materials adjacent to one sheet material that is directly sucked by the vacuum suction apparatus may be separated together with the one sheet material from the other stacked sheet materials.

Further, in the vibrating/separating system disclosed in the JP-A 2004-2044 (KOKAI), it is actually difficult that the slender massive high-frequency vibrator applies a sufficient vibration force to the uppermost sheet material to separate it from the other stacked sheet materials.

### BRIEF SUMMARY OF THE INVENTION

A sheet material separating apparatus according to one aspect of the present invention comprises: a low frictional guide sheet including a first surface and a second surface opposite to the first surface, and making a surface contact with an upper surface of a stack including stacked sheet materials by the first surface; and a vibrator configured to contact the second surface of the guide sheet and to apply a high-frequency vibration to the guide sheet. In this apparatus, a length from a part of the second surface of the guide sheet on which the vibrator contacts to any position on a peripheral edge of the second surface is longer than one wavelength of an excited sound wave, and the guide sheet is separated from an uppermost sheet material in the stack and the uppermost sheet material is separated from the other sheet materials in the stack when the vibrator applies the high-frequency vibration to the guide sheet.

A sheet material separating method according to one aspect of the present invention comprises: making a low frictional guide sheet including a first surface and a second surface opposite to the first surface, a surface contact with an upper surface of a stack including stacked sheet materials by the first surface; and making a vibrator contact the second surface of the guide sheet and applying a high-frequency vibration to the guide sheet by the vibrator. In this method, a length from a part of the second surface of the guide sheet on which the vibrator contacts to any position on a peripheral edge of the second surface is longer than one wavelength of an excited sound wave, and the guide sheet is separated from an uppermost sheet material in the stack and the uppermost sheet material is separated from the other sheet materials in the stack when the vibrator applies the high-frequency vibration to the guide sheet.

### BRIEF DESCRIPTION OF THE SEVERAL VIEWS OF THE DRAWING

FIG. 1 is a schematic side view of a sheet material processing apparatus according to an embodiment of the present invention;

FIG. 2 is a schematic plan view showing a layout of a vibrator and low frictional guide sheet of a separating unit, and a pickup roller of a taking-out unit on an upper surface of a stack including stacked sheet materials, in the processing apparatus;

FIG. 3 shows a result of calculation of a vibration amplitude to be generated in each low frictional guide sheet made of steel when the vibrator vibrates low frictional guide sheets with various thickness by their resonant frequencies;

FIG. 4 shows a result of calculation of a vibration amplitude to be generated in each low frictional guide sheet made of stainless steel when the vibrator vibrates low frictional guide sheets with various thickness by a vibration frequency of 28 KHz, in the same condition as that in FIG. 3 excluding that the thickness of the air layer between the uppermost sheet material in the stack and the guide sheet;

FIG. 5 shows a result of experiment on a reduction rate of friction generated between the uppermost sheet material in the stack and each low frictional guide sheet made of stainless steel when the vibrator vibrates the guide sheets with various thickness by the vibration frequency of 28 KHz in the case of FIG. 4;

FIG. 6 is a schematic side view of a modification of a structure which supports the guide sheet in the processing apparatus according to the embodiment shown in FIGS. 1 and 2; and

FIG. 7 is a schematic side view of another modification of a structure which supports the guide sheet in the processing apparatus according to the embodiment shown in FIGS. 1 and 2.

### DETAILED DESCRIPTION OF THE INVENTION

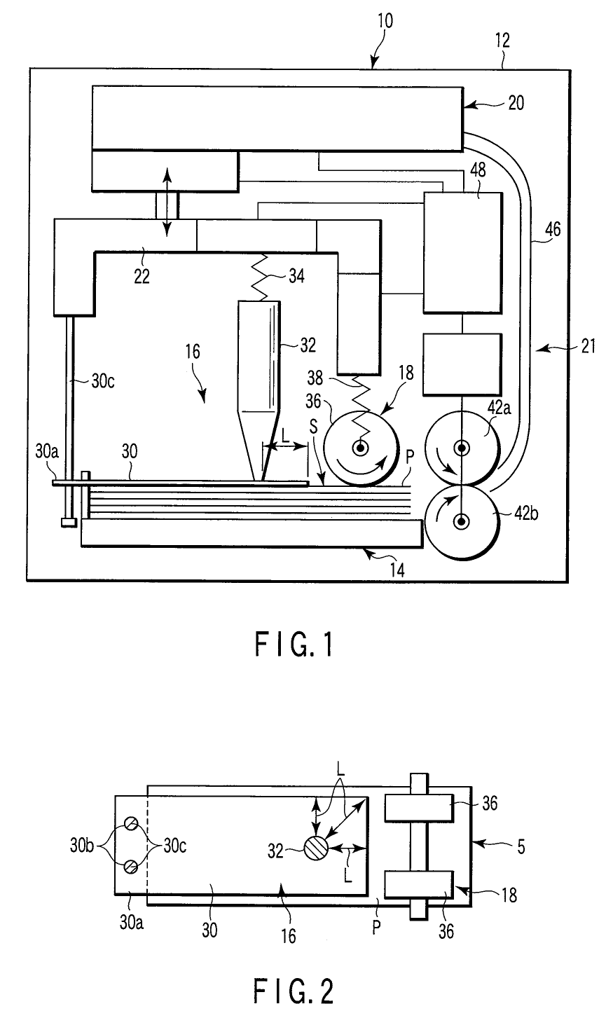

Hereinafter, a sheet material processing apparatus 10 according to an embodiment of the present invention will be explained in detail with reference to FIGS. 1 and 2 in the accompanying drawings.

As shown in FIG. 1, the sheet material processing apparatus 10 comprises an outer housing 12, and a stack holding unit 14 arranged at a predetermined position in an inside space of the outer housing 12. The stack holding unit 14 holds a stack S including stacked sheet materials. The stack holding unit 14 includes a not-shown urging structure which urges the stack holding unit 14 holding the stack S upward.

The sheet material processing apparatus 10 further comprises a sheet material separating unit 16, a sheet material taking-out unit 18, and a sheet material processing unit 20 in the inside space of the outer housing 12.

In the inside space of the outer housing 12, the sheet material separating unit 16 is arranged above the stack S in the stack holding unit 14. And, the sheet material separating unit 16 functions to separate a sheet material P positioned uppermost in the stack S from the other sheet materials in the stack S. The sheet material separating unit 16 configures a sheet material separating apparatus according to an embodiment of the present invention.

In the inside space of the outer housing 12, the sheet material taking-out unit 18 is arranged above one end portion of the stack S. And, the sheet material taking-out unit 18 functions to move the uppermost sheet material P separated from the stack S in the stack holding unit 14 relatively to the stack S, and takes it out from the stack S. The sheet material taking-out unit 18, together with the stack holding unit 14 and the sheet material separating unit 16, configure a sheet material separating/taking-out apparatus according to an embodiment of the present invention.

In the inside space of the outer housing 12, the sheet material processing unit 20 is arranged in a downstream side of the sheet material separating unit 16 and sheet material taking-out unit 18 in a direction in which the sheet material P is taken out from the stack S by the sheet material taking-out unit 18. The sheet material processing unit 20 performs a predetermined process for the sheet material P taken out from the stack S in the stack holding unit 14 by the sheet material taking-out unit 18.

Further, in the inside space of the outer housing 12, a sheet material conveying unit 21 is arranged to convey the sheet material P taken out from the stack S in the stack holding unit 14 by the sheet material taking-out unit 18, to the sheet material processing unit 20.

Further, in the inside space of the outer housing 12, the sheet material separating unit 16 and the taper sheet taking-out unit 18 are supported by a supporting unit 22.

Next, each of configurations of the sheet material separating unit 16, sheet material taking-out unit 18, sheet material processing unit 20 and sheet material conveying unit 21 of the sheet material processing apparatus 10 will be explained with reference to FIGS. 1 and 2.

The sheet material separating unit 16 includes a low frictional guide sheet 30 and a vibrator 32. The low frictional guide sheet 30 includes a first surface and a second surface opposite to the first surface, and makes a surface contact with an upper surface of the uppermost sheet material P in the stack S held in the stack holding unit 14 by the first surface. And, the vibrator 32 contacts the second surface of the low frictional guide sheet 20, and applies a high-frequency vibration to the low frictional guide sheet 30.

In this embodiment, the low frictional guide sheet 30 is made of metal (e.g. stainless steel), and has a predetermined thickness (e.g. 0.1 mm). The low frictional guide sheet 30 projects outward from the other end of the upper surface of the stack S and forms an outward projection 30a. The outward projection 30a is supported to the supporting unit 22 by a supporting structure to be movable in up-and-down directions and not to be movable along the upper surface of the stack S. Such a supporting structure includes, in this embodiment, a pair of vertical through holes 30b formed in the outward projection 30a of the low frictional guide sheet 30, and a pair of bar-shaped guide sheet supporting members 30c each of which extends vertically and has an upper end fixed to the supporting unit 22 and a lower end part inserted into each vertical through hole 30b in the outward projection 30a.

In this embodiment, the vibrator 32 is configured by a combination of a bolt-tightened Langevin type vibration generator and a vibration amplifying horn. The vibrator 32 has a lower end contacting a predetermined position on the second surface of the low frictional guide sheet 30, and an upper end part supported by the supporting unit 22 through an urging structure 34. The urging structure 34 supports the upper end part of the vibrator 32 at a predetermined position of the supporting unit 22 and urges the vibrator 32 downward. A high-frequency vibration generated by the bolt-tightened Langevin type vibration generator in the vibrator 32 is amplified by the vibration amplifying horn, and then the amplified high-frequency vibration is transmitted to the predetermined position on the second surface of the low frictional guide sheet 30 through the lower end of the vibrator 32.

In the low frictional guide sheet 30, a shortest distance on the second surface from the portion of the second surface of the low frictional guide sheet 30, on that portion the lower end of the vibrator 32 contacting, that is, a distance on the second surface from the above described portion of the second surface to any position on a peripheral edge of the second surface, is L that is longer than one wavelength of a sound wave transmitted in an air surrounding the low frictional guide sheet 30. If the above condition about the shortest distance concerning the second surface is satisfied, the low frictional guide sheet 30 can have any shape excepting a square. The shapes excepting the square include a circle, an oval, etc.

In this embodiment, the sheet material taking-out unit 18 includes a so-called pickup roller 36. The pickup roller 36 is rotationally supported at a predetermined position on the supporting unit 22 through an urging structure 38, and the urging structure 38 urges the pickup roller 36 downward. The pickup roller 36 is driven by a predetermined operation by a rotation drive source (such as a stepping motor) not shown in the drawing.

A sheet material, which is separated from the stack S held in the stack holding unit 14 by the sheet material separating unit 16 and which is taken out from the stack S by the sheet material taking-out unit 18, is led into the sheet material conveying unit 21 by conveying rollers 42a and 42b provided at an entrance of the sheet material conveying unit 21.

The sheet material conveying unit 21 includes a sheet material conveying guide structure 46 which includes pairs of conveying rollers not shown in the drawing. The sheet material conveying guide structure 46 conveys the sheet material fed into the sheet material conveying unit 21 by the conveying rollers 42a and 42b provided at the entrance of the sheet material conveying unit 21, to the sheet material processing unit 20 by the not-shown pairs of conveying rollers.

The sheet material processing apparatus 10 is further provided with a control unit 48 in the inside space of the outer housing 12. The control unit 48 is electrically connected to not-shown driving sources for the sheet material processing unit 20, the vibrator 32 of the sheet material separating unit 16, the pickup roller 36 of the sheet material taking-out unit 18, the conveying rollers 42a and 42b of the sheet material conveying unit 21, and the not-shown pairs of conveying rollers of the sheet material conveying guide structure 46, and controls the operations of these components.

When the sheet material processing apparatus 10 according to this embodiment is for example a printer, the sheet material processing unit 20 can be a printing device. When the sheet material processing apparatus 10 is for example a copier, the sheet material processing unit 20 can be an image copying device. When the sheet material processing apparatus 10 is for example an automatic teller machine (ATM), the sheet material processing unit 20 can be a temporary bank note storage at a bank note dispensing port. When the sheet material processing apparatus 10 is for example a processing machine for processing securities including bank notes, the sheet material processing unit 20 can be an authentication/sorting unit. If the sheet material processing apparatus 10 is for example a mail processing apparatus, the sheet material processing unit 20 can be a date stamping device or a zip code reading/delivery district sorting device for mail including postcards and letters.

Next, an operation of the whole sheet material processing apparatus 10 configured as described above will be explained with reference to FIGS. 1 and 2.

While the stack holding unit 14 holding the stack S is placed at the predetermined position in the inner space of the outer housing 12, the control unit 48 moves the sheet material separating unit 16 and the sheet material taking-out unit 18 to close to the upper surface of the stack S held in the stack holding unit 14. As a result, the low frictional guide sheet 30 of the sheet material separating unit 16 comes in contact with the upper surface of the stack S by the first surface facing to the upper surface of the stack S, and the lower end of the vibrator 32 comes in contact with the second surface of the low frictional guide sheet 30, the second surface being opposite to the upper surface of the stack S. At the same time, the pickup roller 36 of the sheet material taking-out unit 18 is brought into contact with a part of the upper surface of the stack S, the part neighboring to one end of the upper surface of the stack S.

And, the control unit 48 controls the vibrator 32 so that its lower end is vibrated at a high frequency, when the sheet material processing unit 20 performs a predetermined process for each of the sheet materials P in the stack S held in the stack holding unit 14.

The high-frequency vibration of the lower end of the vibrator 32 is transmitted to the low frictional guide sheet 30, and generates a coupled oscillation between the low frictional guide sheet 30 and an air existing between the first surface of the low frictional guide sheet 30 and the upper surface of the sheet material P positioned uppermost in the stack S.

As a result, the low frictional guide sheet 30 is securely separated from the uppermost sheet material P. At the same time, the low frictional guide sheet 30 vibrates the uppermost sheet material P to the other sheet materials P in the stack S, and securely separates the uppermost sheet material P from the other sheet materials P.

The high-frequency vibration is transmitted from the lower end of the vibrator 32 to the whole upper surface of the uppermost sheet material P in the stack S through the low friction guide 30. Therefore, the high-frequency vibration is not concentrated in a very limited small area of the upper surface of the uppermost sheet material P (namely, an area corresponding to the lower end of the vibrator 32). This prevents a damage of the very limited small area of the upper surface caused by the concentration of the high-frequency vibration in the very limited small area of the upper surface. For example, when the very limited small area is a part of a translucent paper or transparent synthetic resin film covering a window in an envelope having a window and the high-frequency vibration is applied on that part, the concentrated high-frequency vibration may break, char or burn that part of the translucent paper or transparent synthetic resin film.

The control unit 48 controls the vibrator 32 as described above, and operates the not-shown rotation driving sources for the pickup roller 36, conveying rollers 42a and 42b, and conveying rollers of the sheet material conveying guide structure 46.

In the sheet material separating unit 16, since the low friction guide sheet 30 is separated from the uppermost sheet material P and the uppermost sheet material P is separated from the other sheet materials P in the stack S as described above, the uppermost sheet material P is taken out from the other sheet materials P in the stack S toward a contact point between the conveying rollers 42a and 42b of the sheet material conveying unit 21 along the low frictional guide sheet 30 by a frictional force generated between the uppermost sheet material P and a peripheral surface of the pickup roller 36 contacting the uppermost sheet material P and rotating in the above-mentioned predetermined direction. The taken-out sheet material P is pinched by the pair of conveying rollers 42a and 42b at the contact point and is fed into the sheet material conveying guide structure 46 of the sheet material conveying unit 21 by the pair of conveying rollers 42a and 42b. The sheet material conveying guide structure 46 conveys the fed sheet material P to the sheet material processing unit 20 by the not-shown pairs of conveying rollers. The sheet material processing unit 20 performs the predetermined process for the sheet material P conveyed from the sheet material conveying guide structure 46.

Next, the operation of the sheet material separating unit 16 will be explained in more detail.

The first surface (the lower surface in FIG. 1) of the low frictional guide sheet 30 does not closely in contact with the upper surface of the uppermost sheet material P in the stack S because of their surface roughness, and an air layer always exists between them. When the pickup roller 36 is rotated in the above-mentioned predetermined direction with the vibrator 32 not applying the high-frequency vibration to the low frictional guide sheet 30, a frictional force generated between the uppermost sheet material P and a sheet material second to the uppermost one in the stack S is the same as that in an ordinary frictional take-out method, so that the uppermost sheet material P and the sheet material second to the uppermost sheet material S in the stack S may be fed in an overlapped condition at one time.

When the vibrator 32 applies a high-frequency vibration to the low frictional guide sheet 30, the air layer is vibrated together with the low frictional guide sheet 30 at the high frequency, and the uppermost sheet material P is also vibrated at the high frequency. The low frictional guide sheet 30 and the uppermost sheet material P are different in mass, so that they vibrate in different phases and air is sucked therebetween to increase the thickness of the air layer between the low frictional guide sheet 30 and the uppermost sheet material P. As a result, a true contact area between the low frictional guide sheet 30 and the uppermost sheet material P decrease. At the same time, a true contact area between the uppermost sheet material P and the sheet material second to the uppermost one in the stack S also decrease.

Therefore, if the pickup roller 36 is rotated in the above-mentioned predetermined direction during this situation, a possibility that the uppermost sheet material P and the sheet material second to the uppermost one in the stack S are fed in the overlapped condition at one time becomes very low because the frictional force generated between the uppermost sheet material P and the sheet material second to the uppermost one in the stack S is decreased. And, the pickup roller 36 can easily take out only the uppermost sheet material P from the other sheet materials in the stack S along the low frictional guide sheet 30.

Hereinafter, an analysis model for considering a mechanism and condition that a frictional force between two overlapped sheets (a force necessary to separate the two sheets from each other) is decreased by vibration of the vibrator 32 will be explained. In the following explanation, the vibrator 32 is described as a vibrator, and each of the low frictional guide sheet 30 and uppermost sheet material P in the stack S is described as a thin plate. Further, the thin plate contacting the vibrator (corresponding to the low frictional guide sheet 30) is described as a first thin plate, and the thin plate under the first thin plate (the uppermost sheet material P in the stack S) is described as a second thin plate.

To simplify the analysis, it is assumed that the second thin plate does not vibrate. First, an equation of a flexural vibration of the first thin plate is expressed as [Formula 1].

$$h ρ \frac{{\partial }^{2}}{\partial {t}^{2}} w + \frac{{Qh}^{3}}{12 ( 1 - {s}^{2} )} {Δ}^{2} w = {P}_{2 - 1} - F \qquad [ Formula 1 ]$$

Where:

ρ: Density of the first thin plate

h: Thickness of the first thin plate

w: Displacement of the first thin plate at each position on the coordinates (x, y) in a plane of the first thin plate

P₂₋₁: Pressure of air acting on the first thin plate

F: Contact pressure of the vibrator

Q: Young's modulus of the first thin plate

S: Poisson ratio of the first thin plate

It is considered that the first thin plate moves in accordance with this equation.

Movement of the air layer existing between the first and second thin plates can be expressed by the Navier-Stokes equation and the equation of continuity shown in the following [Formula 2] and [Formula 3].

$$\begin{matrix}ρ \frac{\partial }{\partial t} v + ρ ( v \cdot grad ) v = - gradP + ηΔ v + ( ς + \frac{1}{3} η ) grad \cdot divv & [ Formula 2 ] \\ \frac{\partial }{\partial t} ρ + div ( ρ v ) = 0 & [ Formula 3 ]\end{matrix}$$

In each of Formulas 2 and 3, ρ, P, v, η and ζ are the density, pressure, velocity, coefficient of viscosity and second coefficient of viscosity of a fluid at a certain position and time (air in this case).

For estimating a rough behavior of the fluid, by considering an equation of fluid to the first-degree minute term and by assuming that the first thin plate and the air layer forms a coupled oscillation system, a coupled oscillation system can be expressed by the following simultaneous differential equations.

$$\begin{matrix}ρ h \frac{{\partial }^{2}}{\partial {t}^{2}} {Z}_{Z} ( x , y , {Z}_{H} , t ) + \frac{{Qh}^{3}}{12 ( 1 - {v}^{2} )} {Δ}^{2} {Z}_{Z} ( x , y , {Z}_{H} , t ) = {P}_{1} - F & [ Formula 4 ] \\ {ρ}_{0} \frac{\partial }{\partial t} v = - {gradP}_{1} + ηΔ v + ( ς + \frac{1}{3} η ) grad \cdot divv & [ Formula 5 ] \\ \frac{\partial }{\partial t} {P}_{1} + {c}^{2} {ρ}_{0} div ( v ) = 0 & [ Formula 6 ]\end{matrix}$$

In this simultaneous equations,

ρ: Density of the first thin plate

h: Thickness of the first thin plate

Zz: Displacement at each position in the coordinates (x, y) on the plane of the first thin plate, the coordinates being common to the those of the air layer

P₁: Amount of change in pressure of air in the air layer

F: Contact pressure of the vibrator

Q: Young's modulus of the first thin plate

S: Poisson ratio of the first thin plate

ρ₀: Density of the air layer

v: Velocity of air

η and ζ: Coefficient of viscosity and second coefficient of viscosity of air

By solving the simultaneous differential equation consisting of Formula 4, Formula 5 and Formula 6, a proper vibration condition of the 1st thin plate can be obtained. Further, whether a coupled oscillation system can be vibrated for a set value of vibration frequency can be judged by an existing condition of a real number solution of the simultaneous equation.

As a result of analysis, though the result is different depending on property values of the first thin plate, it is found that there is a vibration condition that can make the first thin plate raise from the second thin plate by vibration while stably keeping a distance of a few tens of μm between the first and second thin plates. By vibrating the first thin plate in a state that satisfies an obtained vibration condition and the property values of the first thin plate, it is possible to make a true contact area between the first and second thin plates become small and a friction generated between the first and second thin plates decrease.

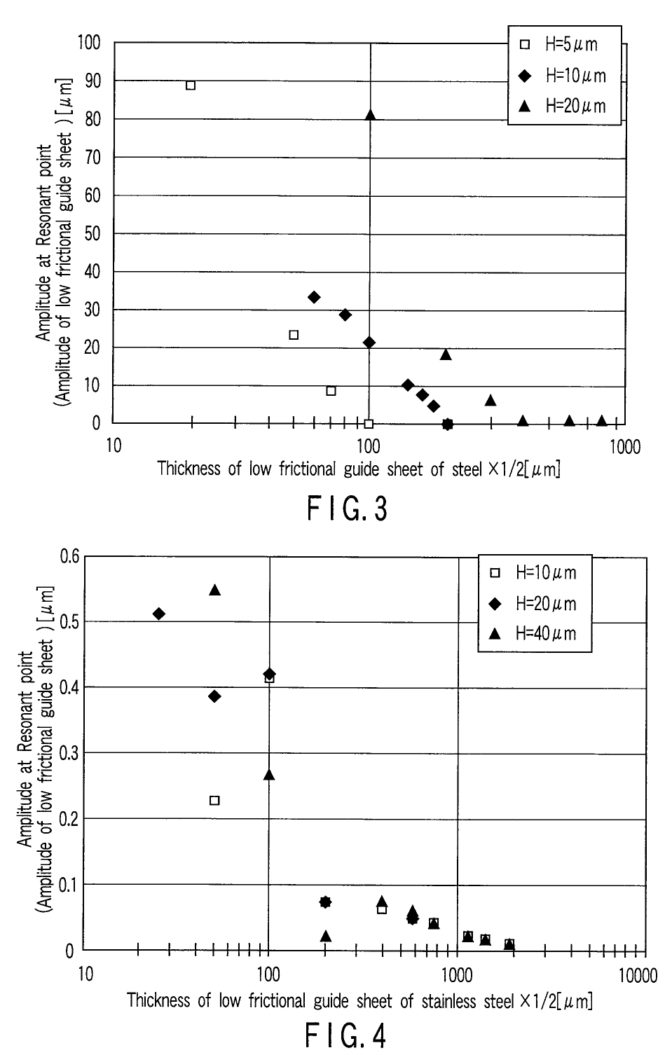

The inventors of this invention calculated the maximum amplitude that each of low frictional guide sheets 30 made of steel with various thickness can vibrates, when each low friction guide sheet 30 is assumed to be vibrated by the vibrator 32 at the resonant frequency of each of the low frictional guide sheets 30 in a condition that a diameter φ of a part of a second surface (the upper surface in FIG. 1) of the low frictional guide sheet 30 is 10 mm, the part on which the vibrator 32 contacting, a force F by which the vibrator 32 pressing the contacting part of the low frictional guide sheet 30 is 300 gf, a frequency f of high frequency vibration generated by the vibrator 32 is the resonant frequency of each low frictional guide sheet 30, and a thickness of an air layer is 5 μm, 10 μm or 20 μm. The calculation results are shown in FIG. 3.

It is seen here that if the thickness of the low frictional guide sheet 30 is 400 μm or less, the low frictional guide sheet 30 can float from the uppermost sheet material P in the stack S. If the thickness of the low frictional guide sheet 30 is 200 μm or less, the low frictional guide sheet 30 can securely floats from the uppermost sheet material P in the stack S at all times, even if the thickness of the air layer is any one of estimated values.

According to similar analysis, a thickness condition of the low frictional guide sheet 30 required to float the low frictional guide sheet 30 from the uppermost sheet material P in the stack S when the low frictional guide sheet 30 is made of aluminum or polystyrene, is obtained from the Formula 1, and it is shown in Table 1.

TABLE 1

| | Young's | Density | Poisson's | Condition |
|---|---|---|---|---|
| | modulus [Pa] | [kg/m³] | ratio | in thickness |
| Steel | 2.10 × 10¹¹ | 7860 | 0.29 | 400 μm or less |
| Aluminum | 7.03 × 10¹⁰ | 2690 | 0.345 | 350 μm or less |
| Polystyrene | 3.50 × 10⁹ | 1056 | 0.34 | 700 μm or less |

The Young's modulus, density and Poisson ratio of each of the steel, aluminum and polystyrene shown in Table 1 can be known from various published documents, for example, Chronological Table of Japanese Science.

Further, by similar analysis, a maximum amplitude that the low frictional guide sheet 30 can vibrate when the low frictional guide sheet 30 is made of stainless steel and the low frictional guide sheet 30 is vibrated at 28 KHz, is calculated. And, a result of the calculation is shown in FIG. 4.

The Young's modulus, density and Poisson ratio of a stainless steel used in this calculation are 1.95×10¹¹ [Pa], 7800 [kg/m³] and 0.3, respectively.

It is also seen here that if the thickness of the low frictional guide sheet 30 is 200 μm or less, the low frictional guide sheet 30 can be securely floated from the uppermost sheet material P in the stack S at any time, even if the thickness of the air layer is any one of estimated values.

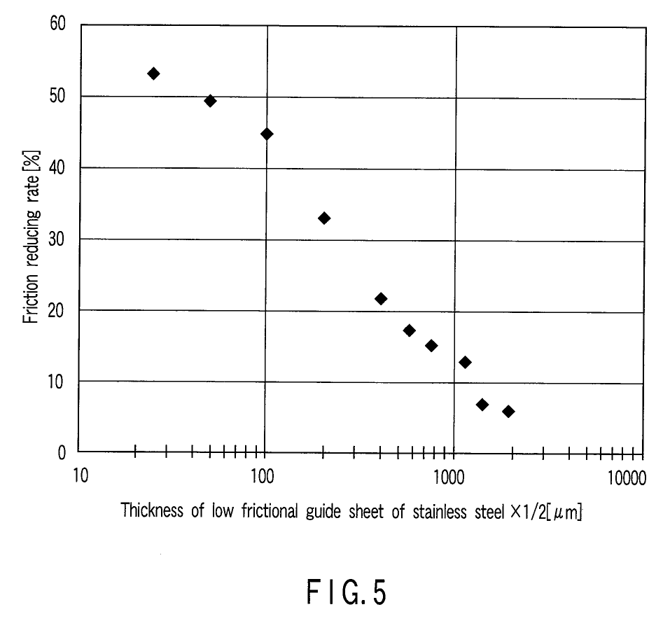

Instead of the maximum amplitude that the low frictional guide sheet 30 can vibrate, a friction force generated between a first surface (the lower surface in FIG. 1) of the low frictional guide sheet 30 and the upper surface of the sheet material P is confirmed by an experiment under the same condition as that in the case of FIG. 4. The result is shown in FIG. 5.

According to this result, it is seen that if the thickness of the low frictional guide sheet 30 is 200 am or less, the friction force generated between the first surface (the lower surface in FIG. 1) of the low frictional guide sheet 30 and the upper surface of the sheet material P can be securely and sufficiently decreased at all times.

The low frictional guide sheet 30 is floated from the upper surface of the uppermost sheet material P by a compressed wave of an air transmitted in the air layer. Therefore, of course, a length L from the part of the vibrator 32 contacting the low frictional guide sheet 30 to any position on a peripheral edge of the first surface of the low frictional guide sheet 30, the first surface contacting the upper surface of the uppermost sheet material P in the stack S, must be longer than one wavelength of a sound wave transmitted in an air surrounding the low frictional guide sheet 30. For example, one wavelength of the sound wave transmitted in air at 25° C. with an atmospheric pressure is 12.1 mm.

The inventors of this invention used a stainless steel plate of 0.1 mm in thickness, 148 mm in width and 100 mm in length, as the low frictional guide sheet 30 under the above-mentioned conditions. As a result, the low frictional guide sheet 30 can be separated sufficiently from the uppermost sheet material P in the stack S, and also the uppermost sheet material P can be sufficiently separated from the sheet material P positioned second to the uppermost one in the stack S.

In the sheet material processing apparatus 10 according to the embodiment of this invention shown in FIGS. 1 and 2, the structure which supports the low frictional guide sheet 30 to be movable in the up and down directions relative to the supporting unit 22 and not to be movable along the upper surface of the stack S, includes the pair of vertical through holes 30b formed in the outward projection 30a of the low frictional guide sheet 30 and the pair of bar-shaped guide sheet support members 30c each of which extends in the up and down directions and each has the upper end fixed to the supporting unit 22 and the lower end inserted into each of the vertical through holes 30b.

However, the low frictional guide sheet 30 can be supported by the supporting unit 22 through other supporting structures than the structure described above with reference to FIGS. 1 and 2, as long as the other supporting structures satisfy following conditions. These conditions are that the low frictional guide sheet 30 can be floated and separated from the upper surface of the stack S when a high frequency vibration is applied to the low frictional guide sheet 30 by the vibrator 32, so that a friction generated between the low frictional guide sheet 32 and the uppermost sheet material P in the stack S can be decreased to allow the uppermost sheet material P to be taken out from the other sheet materials in the stack S along the low friction guide 30 by the pickup roller 36 of the sheet material taking-out unit 18.

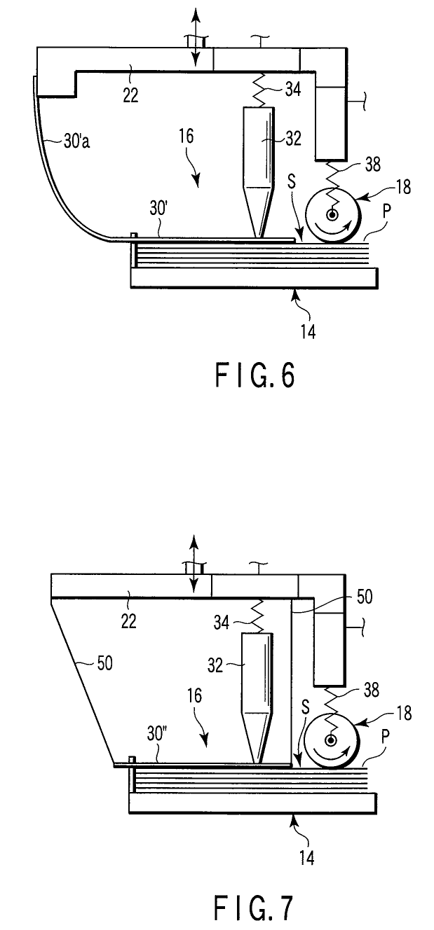

Examples of such other supporting structure are shown in FIGS. 6 and 7. In each of FIGS. 6 and 7, members corresponding to those in the sheet material processing apparatus 10 according to the embodiment of the invention described above with reference to FIGS. 1 and 2 are designated by the same reference numerals as those designating the corresponding members, and detailed explanation of these members will be omitted.

In the supporting structure shown in FIG. 6, the outward projection 30′a of the low frictional guide sheet 30′ extends away from the stack S and gradually approaches to the supporting unit 22. The projected end portion of the outward projection 30′a is fixed to the supporting unit 22 directly or indirectly through a known free bending structure including a hinge.

In the supporting structure shown in FIG. 7, both end portions of the low frictional guide sheet 30″ are attached to the supporting unit 22 by flexible linear elements 50.

Additional advantages and modifications will be readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A sheet material separating apparatus comprising:
a low frictional guide sheet including a first surface and a second surface opposite to the first surface, and making a surface contact with an upper surface of a stack including stacked sheet materials by the first surface; and
a vibrator contacting the second surface of the guide sheet and applying a high-frequency vibration to the guide sheet,
wherein a length from a part of the second surface of the guide sheet on which the vibrator contacts to any position on a peripheral edge of the second surface is longer than one wavelength of an excited sound wave, and
the guide sheet is separated from an uppermost sheet material in the stack and the uppermost sheet material is separated from the other sheet materials in the stack when the vibrator applies the high-frequency vibration to the guide sheet.

2. The apparatus according to claim 1, wherein a thickness between the first and second surfaces of the guide sheet is set to generate a coupled oscillation of a real wave number between the guide sheet and an air existing between the first surface of the guide sheet and the upper surface of the stack while the vibrator applies a high-frequency vibration to the guide sheet.

3. The apparatus according to claim 1, wherein the guide sheet is made of metal.

4. A sheet material separating/taking-out apparatus comprising:
a stack holding unit configured to hold a stack including stacked sheet materials;
a separating unit configured to separate a sheet material positioned uppermost in the stack from the other sheet materials in the stack; and
a taking-out unit configured to move the separated sheet material relatively to the stack and to take out the separated sheet material from the stack,
wherein the separating unit includes
a low frictional guide sheet including a first surface and a second surface opposite to the first surface and making a surface contact with an upper surface of the stack by the first surface, and
a vibrator contacting the second surface of the guide sheet and applying a high-frequency vibration to the guide sheet, and
wherein a length from a part of the second surface of the guide sheet on which the vibrator contacts to any position on the peripheral edge of the second surface is longer than one wavelength of an excited sound wave, and
wherein the guide sheet is separated from an uppermost sheet material in the stack and the uppermost sheet material is separated from the other sheet materials in the stack when the vibrator applies the high frequency vibration to the guide sheet.

5. The apparatus according to claim 4, wherein a thickness between the first and second surfaces of the guide sheet is set to generate a coupled oscillation of a real wave number between the guide sheet and an air existing between the first surface of the guide sheet and the upper surface of the stack while the vibrator applies a high-frequency vibration to the guide sheet.

6. The apparatus according to claim 4, wherein the guide sheet is made of metal.

7. The apparatus according to claim 4, wherein the taking-out unit includes a take-out roller rotating in a predetermined direction while the roller contacts an upper surface of the uppermost sheet material in the stack, and taking out the uppermost sheet material from the other sheet materials in the stack by a friction generated between the roller and the upper surface of the uppermost sheet material.

8. A sheet material processing apparatus comprising:
a stack holding unit configured to hold a stack including stacked sheet materials;
a separating unit configured to separate a sheet material positioned uppermost in the stack from the other sheet materials in the stack;
a taking-out unit configured to move the separated sheet material relatively to the stack and to take out the separated sheet material from the stack; and
a processing unit configured to perform a predetermined process for the taken-out sheet material,
wherein the separating unit includes
a low frictional guide sheet including a first surface and a second surface opposite to the first surface and making a surface contact with an upper surface of the stack by the first surface, and
a vibrator contacting the second surface of the guide sheet and applying a high-frequency vibration to the guide sheet, and
wherein a length from a part of the second surface of the guide sheet on which the vibrator contacts to any position on the peripheral edge of the second surface is longer than one wavelength of an excited sound wave, and
wherein the guide sheet is separated from an uppermost sheet material in the stack and the uppermost sheet material is separated from the other sheet materials in the stack when the vibrator applies the high frequency vibration to the guide sheet.

9. The apparatus according to claim 8, wherein a thickness between the first and second surfaces of the guide sheet is set to generate a coupled oscillation of a real wave number between the guide sheet and an air existing between the first surface of the guide sheet and the upper surface of the stack while the vibrator applies a high-frequency vibration to the guide sheet.

10. The apparatus according to claim 8, wherein the guide sheet is made of metal.

11. The apparatus according to claim 8, wherein the taking-out unit includes a take-out roller rotating in a predetermined direction while the roller contacts an upper surface of the uppermost sheet material in the stack, and taking out the uppermost sheet material from the other sheet materials in the stack by a friction generated between the roller and the upper surface of the uppermost sheet material.

12. A sheet material separating method comprising:
making a low frictional guide sheet including a first surface and a second surface opposite to the first surface, a surface contact with an upper surface of a stack including stacked sheet materials by the first surface; and
making a vibrator contact the second surface of the guide sheet and applying a high-frequency vibration to the guide sheet by the vibrator,
wherein a length from a part of the second surface of the guide sheet on which the vibrator contacts to any position on a peripheral edge of the second surface is longer than one wavelength of an excited sound wave, and
the guide sheet is separated from an uppermost sheet material in the stack and the uppermost sheet material is separated from the other sheet materials in the stack when the vibrator applies the high-frequency vibration to the guide sheet.

13. A sheet material separating/taking-out method comprising:
holding a stack including stacked sheet materials in a stack holding unit;
separating a sheet material positioned uppermost in the stack from the other sheet materials in the stack; and
moving the separated sheet material relatively to the stack and taking out the separated sheet material from the stack,
wherein separating the sheet material includes making a low frictional guide sheet including a first surface and a second surface opposite to the first surface, a surface contact with an upper surface of the stack by the first surface, and
making a vibrator contact the second surface of the guide sheet and applying a high-frequency vibration to the guide sheet by the vibrator, and
wherein a length from a part of the second surface of the guide sheet on which the vibrator contacts to any position on the peripheral edge of the second surface is longer than one wavelength of an excited sound wave, and
wherein the guide sheet is separated from an uppermost sheet material in the stack and the uppermost sheet material is separated from the other sheet materials in the stack when the vibrator applies the high frequency vibration to the guide sheet.
